(19) United States
(12) Patent Application Publication
(10) Pub. No.: US 2016/0044520 A1
(43) Pub. Date: Feb. 11, 2016

(54) MOBILE AUTOMATION TEST PLATFORM

(71) Applicant: Verizon Patent and Licensing Inc., Arlington, VA (US)

(72) Inventors: Krishna IYER, Aurora, IL (US); Arulvadivel VENUGOPAL, Franklin Park, NJ (US)

(21) Appl. No.: 14/456,778

(22) Filed: Aug. 11, 2014

(51) Int. Cl. H04W 24/08; G06F 3/0484; H04W 24/10

(52) U.S. Cl. CPC H04W 24/08; H04W 24/10; G06F 3/04842

(57) ABSTRACT

A system and method are provided for testing mobile applications. A set of mobile devices, a set of applications associated with the mobile devices, and a set of test cases each associated with at least one of the applications are registered at a server. A set of test stations for executing the set of test cases are also registered at the server. Execution of one or more of the test cases on one or more mobile devices at one or more of the test stations is scheduled based on a user request received from at least one client device. Timing of the scheduled test cases is analyzed to determine occurrence of the scheduling time. The scheduled test cases are automatically executed on the test stations with ability to capture necessary logs and screenshot. The execution results are sent to the client device for display to the user for evaluation.

### BACKGROUND

Testing mobile devices involves monitoring, troubleshooting, verification and validation of hardware devices as well as software applications. Mobile device manufacturers develop mobile devices with various operating systems and/or various versions of the same operating systems. Therefore, various applications developed for mobile devices may have to be tested with multiple operating systems and/or with various versions of the same operating system. To this end, the testing process can be challenging and can greatly impact application quality, time-to-market, and profitability of application products.

Known mobile testing methods aiming at certification of applications for mobile devices involve testing quality of applications running on mobile devices prior to the devices being launched (pre-launch) and subsequent to the launch (post-launch) in terms of device certification. Prior to device launch, the devices and their pre-loaded applications may be tested and verified. In addition, mobile devices may be tested after device launch for software and application updates that are constantly upgraded on the devices such as, for example, Smartphones, Tablets, etc., to verify that the applications function properly. For example, if m device types need to be tested for n applications, in order to insure that every application functions properly on every device type, number of pre-launch required tests will be m×n. In addition, each of the n applications may need to be updated multiple (p) times after launch, leading to a total number of m×n×p post-launch tests. However, the known testing methods include manual testing of mobile devices. Naturally, manual testing of mobile devices can be slow, costly, error prone and time consuming. Therefore, a need exists for automated testing of mobile devices and related applications.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a high-level functional block diagram of an exemplary network that provides various communications for mobile devices and supports an example of the mobile automation test suite according to one implementation.

FIG. 2 is a schematic illustration of a mobile automation test platform, according to an implementation.

FIG. 3 is an exemplary process for providing mobile automation test.

FIGS. 4A-4E illustrate various exemplary configurations for hosting the mobile devices subject to testing process.

FIG. 5 is a high-level functional block diagram of an exemplary non-touch type mobile device that may utilize the mobile automation test service through a network/system like that shown in FIG. 1.

FIG. 6 is a high-level functional block diagram of an exemplary touch screen type mobile device that may utilize the mobile automation test service through a network/system like that shown in FIG. 1.

FIGS. 7A-7L are exemplary screenshots provided by the mobile automation test platform shown in FIG. 2.

FIG. 8 is a simplified functional block diagram of an exemplary computer that may be configured as a host or server.

FIG. 9 is a simplified functional block diagram of an exemplary personal computer or terminal device.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

As the types of mobile devices and type and number of software applications provided for mobile devices by enterprises increase, testing of the mobile devices and the applications to insure quality and performance of applications running on mobile devices become more challenging. Even within a single application, modifications and changes in features and components of the application may have different hardware and software requirements and may need to be tested on mobile devices to insure the quality of services provided by the application when running on the mobile devices. As a result, the task of testing multiple applications on multiple devices, currently performed manually, becomes a complex and time and resource consuming task. Therefore, a need exists for automated testing of mobile devices and related applications that require less cost and consume less time, such that test cases can be automatically configured and executed, identifying issues associated with the tested applications.

In one implementation, a mobile automation test platform is provided that allows a user (e.g., a tester) to connect to a server (e.g., a test server) for example via a website. Once connected to the server, the mobile automation test platform can execute one or more test cases on a mobile device without having to manually initialize the test session or setup the test process for example by determining compatibility of the mobile device with a test station, downloading device drivers, etc. The configuration of the test session and setup process can be automatically performed based on data and instructions provided at a configuration step and/or a registration step discussed in more detail hereafter.

In some instances, the mobile automation test platform can test mobile devices that are connected to the test station via a client device. The client device can be connected to the test server and the test server can have multiple test stations, where the mobile devices are connected and managed by the tester using the mobile automation test platform.

In some instances, the mobile automation test platform is an end-to-end solution for testing mobile devices specifically designed for device/application verification needs. The mobile automation test platform can adapt to fast changing mobile device Operating Systems (OS) without rooting the device. The mobile automation test platform provides a plug and play solution that does not require external hardware dependency to execute testing. The system may include a test server, a set of test stations and a “thin client” software where the device screen can be visible on any OS platform, independent of client devices. The mobile devices being tested can be connected to test stations, to client devices (local devices), or directly to the server making it a flexible test platform.

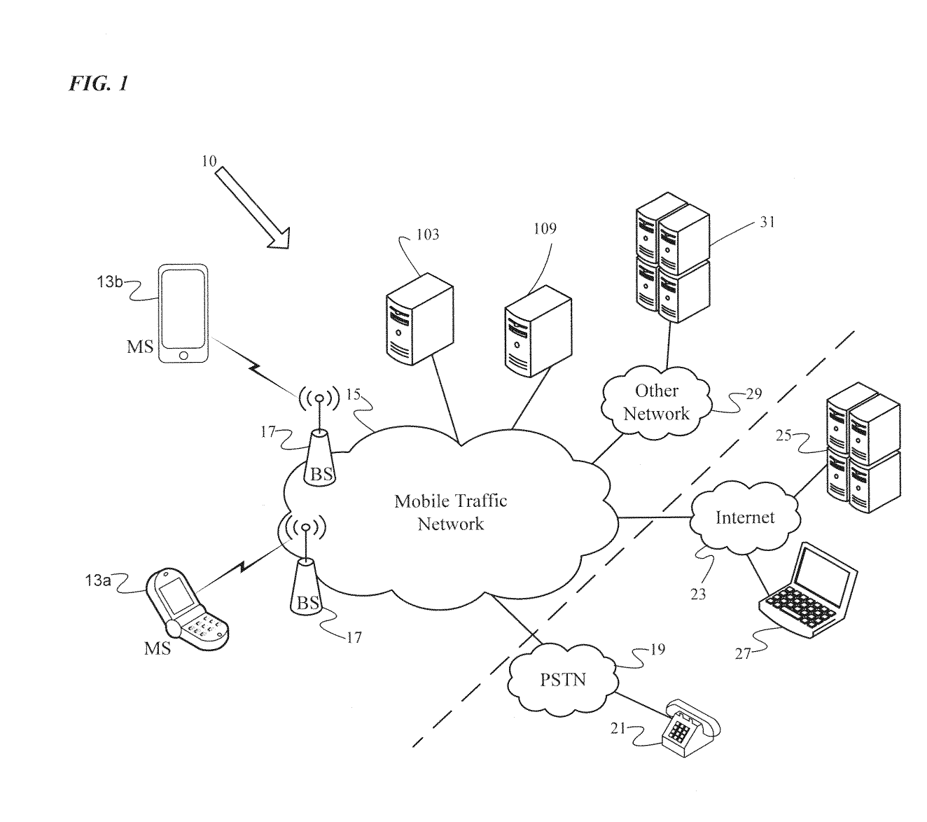

Reference now is made in detail to the examples illustrated in the accompanying drawings and discussed below. FIG. 1 is a high-level functional block diagram of an exemplary network 10 that provides various communications for mobile devices and supports an example of the mobile automation test suite by a mobile automation test platform 103, according to one implementation. The mobile automation test platform 103 can provide mobile automation testing for test suites provided by a test server 109 for one or more mobile applications. The one or more mobile applications can be provided by the application servers 31 and 25 to the mobile devices 13a and 13b and the user terminals 27. The example shows simply two mobile devices (MSs) 13a and 13b as well as a mobile communication network 15. The stations 13a and 13b are examples of mobile devices that may be used for accessing various applications residing on the device and application tests. The various applications may be provided by the application servers 31 or 25. The various application tests may be provided by a test server 109. The application servers 31, 25 and the test server 109 may be managed by the mobile automation test platform 103.

Although two mobile stations are shown, the network will provide similar communications for many other similar users as well as for mobile devices/users that may not participate in the mobile automation test services. The network 15 provides mobile wireless communications services to those stations as well as to other mobile devices (not shown), for example, via a number of base stations (BSs) 17. The present techniques may be implemented in any of a variety of available mobile networks 15 and/or on any type of mobile device compatible with such a network 15, and the drawing shows only a very simplified example of a few relevant elements of the network 15 for purposes of discussion here.

The wireless mobile communication network 15 might be implemented as a network conforming to the code division multiple access (CDMA) IS-95 standard, the 3rd Generation Partnership Project 2 (3GPP2) wireless Internet Protocol (IP) network standard or the Evolution Data Optimized (EVDO) standard, the Long Term Evolution (LTE), the 3rd Generation Partnership Project (3GPP) Wireless IP standard, Global System for Mobile (GSM) communication standard, a time division multiple access (TDMA) standard or other standards used for public mobile wireless communications. The mobile devices 13a and 13b may be capable of voice telephone communications through the network 15, and for accessing applications tested by the mobile automation test platform 103. The exemplary devices 13a and 13b are capable of data communications through the particular type of network 15 (and the users thereof typically will have subscribed to data service through the network).

The network 15 allows users of the mobile devices such as 13a and 13b (and other mobile devices not shown) to initiate and receive telephone calls to each other as well as through the public switched telephone network or “PSTN” 19 and telephone stations 21 connected to the PSTN. The network 15 typically offers a variety of data services via the Internet 23, such as downloads, web browsing, email, etc. By way of example, the drawing shows a laptop PC type user terminal 27 as well as a server 25 connected to the Internet 23; and the data services for the mobile devices 13a and 13b via the Internet 23 may be with devices like those shown at 25 and 27 as well as with a variety of other types of devices or systems capable of data communications through various interconnected networks. The mobile devices 13a and 13b of users also can receive and execute applications written in various programming languages, as discussed in more detail below.

Mobile devices 13a and 13b can take the form of portable handsets, smart-phones or personal digital assistants, although they may be implemented in other form factors. Program applications, provided by the internet server 25 or the application server 31 to the mobile devices 13a, 13b and computing devices 27 can be configured to execute on many different types of mobile devices 13a and 13b. For example, a mobile device application can be written to execute on a binary runtime environment for mobile (BREW-based) mobile device, a Windows Mobile based mobile device, Android based OS (Operating System), IOS based OS, Blackberry based mobile device, or the like. Some of these types of devices can employ a multi-tasking operating system.

The mobile communication network 10 can be implemented by a number of interconnected networks. Hence, the overall network 10 may include a number of radio access networks (RANs), as well as regional ground networks interconnecting a number of RANs and a wide area network (WAN) interconnecting the regional ground networks to core network elements. A regional portion of the network 10, such as that serving mobile devices 13a and 13b, can include one or more RANs and a regional circuit and/or packet switched network and associated signaling network facilities.

Physical elements of a RAN operated by one of the mobile service providers or carriers include a number of base stations represented in the example by the base stations (BSs) 17. Although not separately shown, such a base station 17 can include a base transceiver system (BTS), which can communicate via an antennae system at the site of base station and over the airlink with one or more of the mobile devices 13a and 13b, when the mobile devices are within range. Each base station can include a BTS coupled to several antennae mounted on a radio tower within a coverage area often referred to as a “cell.” The BTS is the part of the radio network that sends and receives Radio Frequency (RF) signals to/from the mobile devices 13a and 13b that are served by the base station 17.

The radio access networks can also include a traffic network represented generally by the cloud at 15, which carries the user communications and data for the mobile devices 13a and 13b between the base stations 17 and other elements with or through which the mobile devices communicate. The network can also include other elements that support functionality other than device-to-device media transfer services such as messaging service messages and voice communications. Specific elements of the network 15 for carrying the voice and data traffic and for controlling various aspects of the calls or sessions through the network 15 are omitted here form simplicity. It will be understood that the various network elements can communicate with each other and other aspects of the mobile communications network 10 and other networks (e.g., the public switched telephone network (PSTN) and the Internet) either directly or indirectly.

The carrier will also operate a number of systems that provide ancillary functions in support of the communications services and/or application services provided through the network 10, and those elements communicate with other nodes or elements of the network 10 via one or more private IP type packet data networks 29 (sometimes referred to as an Intranet), i.e., a private networks. Generally, such systems are part of or connected for communication via the private network 29. A person skilled in the art, however, would recognize that systems outside of the private network could serve the same functions as well. Examples of such systems, in this case operated by the network service provider as part of the overall network 10, which communicate through the intranet type network 29, include one or more application servers 31. In addition one or more test servers 109 may also communicate via the network 15 (as shown in FIG. 1) or through an intranet type network 29 (not shown).

A mobile device 13a or 13b communicates over the air with a base station 17 and through the traffic network 15 for various voice and data communications, e.g. through the Internet 23 with a server 25 and/or with application servers 31. To insure that the application service offered by application servers 25 or 31 is available to only authorized devices/users, the provider of the application service may also deploy a mobile automation test service. In addition, the provider of the application service may also deploy testing services by a test server 109 to test quality and performance of provided applications. The test server 109 can communicate with a mobile automation test platform 103. The mobile automation test platform 103 may be configured to automate the testing of applications by the test server 109. The mobile automation test platform 103 can be a separate physical server as shown, or the mobile automation test platform 103 can be implemented as another program module running on the same hardware platform as the test server 109. When the test server (server 109 in our example) receives a service request from a client application on a mobile device 13a or 13b or a user terminal 27, the test server 109 provides appropriate information to the mobile automation test platform 103. The mobile automation test platform 103 uses the information provided by the test server 109 to communicate with and test the mobile device 13a or 13b or user terminal 27. Upon successful completion of the testing process, the mobile automation test platform 103 informs the test server 109, which in turn provides test reports to the application providers (e.g., application servers 31 or 25) via data communication through the various communication elements (e.g. 29, 15 and 17) of the network 10. The test services provided by the test server 109 and the mobile automation test platform 103 may be provided via the server 31 or 25, if there is an appropriate arrangement between the carrier and the operator of server 31 or 25, by a program on the server 31 or 25 or via a separate authentication server (not shown) connected to the Internet 23 or the network 29.

Servers such as 25 and 31 may provide any of a variety of common application or service functions in support of or in addition to an application program running on the mobile device 13a, 13b, or a user terminal 27. However, for purposes of further discussion, we will focus on functions thereof in support of the mobile automation test service. For a given service, including the mobile automation test service, an application program within the mobile device may be considered as a ‘client application’ and the programming at 103, 109, 25 or 31 may be considered as the ‘server’ application for the particular service.

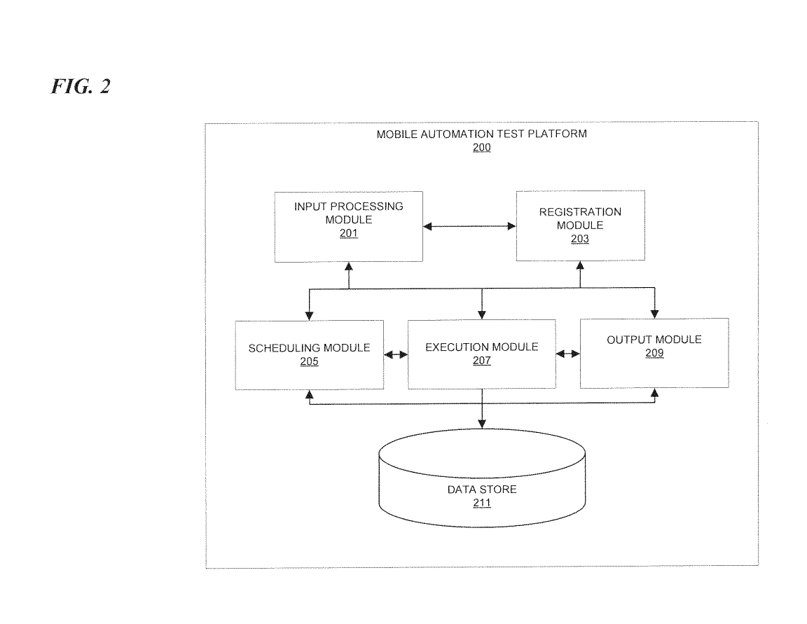

FIG. 2 is a schematic illustration of a mobile automation test platform, according to an implementation. The mobile automation test platform 200 can be similar to the mobile automation test platform 103 of FIG. 1. As shown in FIG. 2, the mobile automation test platform 200 may include an input processing module 201, a registration module 203, a scheduling module 205, an execution module 207, an output module 209, and a data store 211. As used herein, a module can be, for example, any assembly and/or set of operatively-coupled electrical components, and can include, for example, a memory, a processor, electrical traces, optical connectors, software (executing or to be executed in hardware) and/or the like. Furthermore, a module can be capable of performing one or more specific functions associated with the module, as discussed further below.

The mobile automation test platform 200 can provide automation of tests provided by a test server 109 to applications provided by the application servers 31 and 25 for the mobile devices 13a and 13b and the user terminals 27. In some instances, the input processing module 201 receives data associated with a set of applications provided by one or more application servers 31 or 25 for a set of mobile devices 13a and 13b. The data may include a set of test cases for testing each of the applications on each of the mobile devices 13a and 13b. The input processing module 201 may receive the data from a test server 109 of FIG. 1 or from an application server 31 or 25. The data may also include configuration data associated with the test cases, for the mobile devices and for the applications. The input processing module 201 may store the data in data store 211.

In some instances, the registration module 203 registers the set of mobile devices 13a and 13b, the set of applications provided by the application server 31 or 25 associated with the mobile devices 13a and 13b, and the set of test cases (each associated with one of the mobile devices and one of the applications), at the test server 109. The registration by the registration module 203 may include configuration of a test process by identifying the test cases, the application being tested, and the mobile devices being tested. The registration of an application may also include a number of mobile devices 13a and 13b that the application requires for execution.

In some instances, the registration module 203 registers a set of test stations for executing the test cases. The registration of test stations may include configuration of one or more test stations that execute the test cases. A test station can be a computing device such as the user terminal 27. In some instances, the test stations host the test cases and various client devices can connect to the test stations to request execution of the test cases on one or more mobile devices. A client device can also be a computing device such as a user terminal 27 associated with a user as a tester who manages the test process. The registration of the test stations may further include reservation of test stations for test cases and mobile devices. Reservation of test stations may also include allocating test stations to individual client devices such that each test station is capable of being connected to multiple mobile devices 13a and 13b via one or more client devices depending on the needs of each client location. Client devices may be co-located with the test stations or located at different locations from the test stations. In various instances, the mobile devices 13a and 13b can be connected to the test stations, to the client devices, to the test server 109 or to the mobile automation test platform 200.

In some instances, the test server 109 or the mobile automation test platform 200 may have a library of test cases from which one or more test cases may be selected. The library of test cases may include test cases for testing, for example, WiFi, BlueTooth, or Airplane mode of the mobile device. The library of test cases may also include test cases for testing various applications on the mobile device. The library can be stored in data store 211, at the test server 109 or anywhere throughout the network accessible to the test server 109 and the mobile automation test platform 200 via the communication network 15.

In some instances, the scheduling module 205 can schedule one or more test cases at the test server 109 to be executed on one or more mobile devices 13a or 13b at one or more of the registered test stations. The scheduling may be performed based on a user (e.g., a tester) request. The user request may be received from a client device operated by the user. As noted above, the client device may be remote from the test station, for example connected to the test station via a Wide Area Network (WAN) or may be located within close proximity of the testing station, for example within a Local Area Network (LAN) of an organization. The scheduling module 205 may store the test schedules in data store 211.

In some instances, the execution module 207 executes, the scheduled one or more test cases on the one or more test stations based on the schedule provided by the scheduling module 205. The scheduled one or more test cases may be run immediately and/or may be scheduled to run at one or more later dates. The execution module 207 may store the test results in data store 211. In some instances, the output module 209 provides the execution results to the requesting user. The results may be displayed on the client device associated with the requesting user.

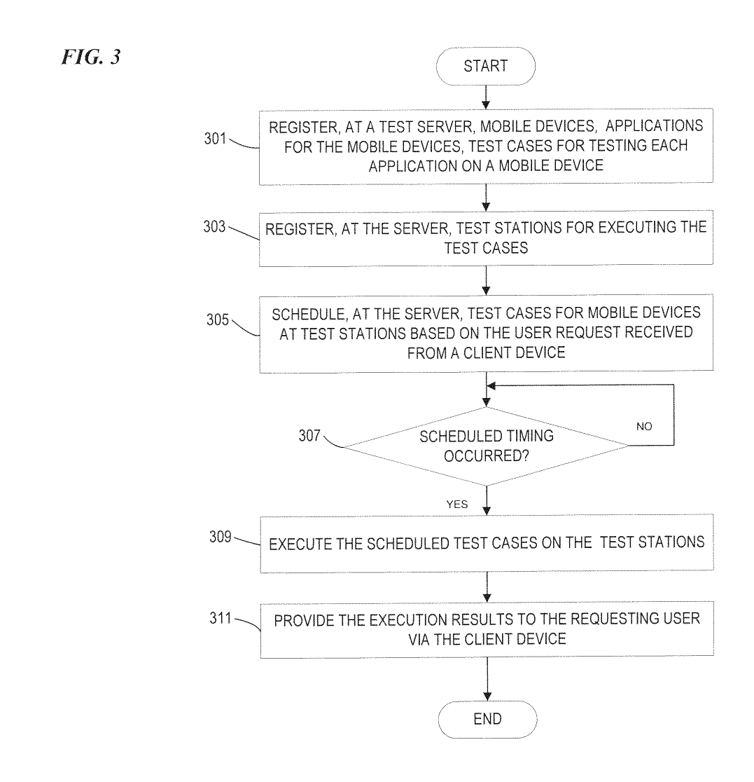

FIG. 3 is an exemplary process for providing mobile automation test. Although FIG. 3 is described with reference to FIGS. 1 and 2, the subject technology is not limited to such and can apply to other computing devices and systems. At block 301, the registration module 203 registers a set of mobile devices 13a and 13b, a set of applications provided by application servers 25 or 31 for the set of mobile devices 13a and 13b, and a set of test cases defined for testing the applications on the mobile devices. Each test case is associated with one or more of the mobile devices 13a and 13b and one or more of the applications. For example, a mobile device 13a can be registered based on attributes such as the model, the Operation System, the version of the Operating System, device configurations such as internal memory space, etc. Similarly, an application can be registered based on the application requirements such as, for example, the processing power or the memory requirements of the application, and the test cases can be registered based on the mobile device models and the application the test cases have been provided for.

At block 303, the registration module 203 registers a set of test stations or computing devices designated to host the test cases and manage execution of test cases on the mobile devices. In addition, the registration module 203 may also register one or more users (e.g., testers) and one or more client devices associated with the users that monitor testing process. In some instances, the input processing module 201 may receive a request from a user for registering a client device of the user. The registration module 203 receives the request from the input processing module 201 and registers the client device, for example, by reserving a test station corresponding with the client device based on a test plan provided by the test server 109 or the application that is going to be tested. In some instances, the registration module 203 can initiate registration process when a mobile device is connected to a test station via a client device or the mobile device is selected from a list of registered mobile devices, for example, from a screen on the client device displaying a list of registered mobile devices. For example, the user of the client device may send a message or a command to the test station indicating that the mobile device is connected to the client device. Similarly, a test case or a test station can also be selected. The registration may include identifying requirements of each application that is going to be tested such as number of devices the application requires to run, memory requirement for the application, models and types of equipments that the application is provided for, etc. The registration may also include selecting test stations and associating the test stations to test cases, mobile devices and client devices.

At block 305, the scheduling module 205 schedules execution of test cases at the mobile automation test platform 200. The scheduling of test cases may include providing a schedule for executing one or more of the registered test cases on one or more registered mobile devices connected to one or more of the registered test stations. The scheduling may be done based on a user request received from a registered client device through which the mobile devices connect with the test stations. The scheduling may include adding the test cases into a queue to be executed based on the schedule. At block 307, the execution module 207 analyzes timing of the scheduled test cases and upon determining an occurrence of the scheduled timing, at block 309, the execution module 207 automatically executes the scheduled test cases on the one or more test stations. In some instances, the user is permitted to start, stop, or pause the execution of the scheduled test cases via the client device. For example, the input processing module 201 may receive a request from the registered user to start, stop, or pause execution of a test case. The input processing module 201 can send the request to the registration module 203. The registration module 203 can verify whether a profile of the registered user, for example stored in data store 211, associates an authorization to the user for the requested function (e.g., start, stop, or pause a test case). If the user is authorized to request the function, the registration module 203 can notify the execution module 207 to apply the requested function on the respective test case. In some other instances, the user may select various functions that can be performed in the event of test failure or test success. In other instances, the functions may be determined by an application provider via application servers 25 or 31, by a test server 109, or by the mobile automation test platform 200. For example, the function may indicate that if the test fails, a message including data associated with the error can be sent, via the output module 209, to the client device, to an application provider, to a manufacturer of the mobile device 13a and 13b, or a combination thereof.

At block 311, the output module 209 sends the execution results to the client device 101a-101n associated with the requesting user for displaying the results to the user, for example via a user interface of the client device. In some instances, upon completion of a test case, the output module 209 can generate a report along with screenshots captured for every executed step of the test case. The output module 209 can store the report in data store 211. The output module 209 may provide the report to the user, to application developers, to system administrators, to the test server 109, to the application server 25 or 31, etc. based on one or more predefined configurations. In some instances, the mobile automation test platform 200 can be integrated with an issue tracking system to produce a report (e.g., open tickets) on problems identified during test run. The issue reports can be stored on data store 211.

The automatic execution of the test cases by the execution module 207 may include storing an execution log associated with the execution. The execution log may include various data collected during the execution, for example by the execution module 207 and one or more screenshots of screens displayed on a client device, on the mobile device being tested, or on the test station, during the execution. The execution report 207 may also generate an execution report based on the execution log. The execution report can include various statistics related to the execution such as, for example, number of successful tests, number of failed tests, success rate, failure rate, etc. In some instances, the execution module 207 may execute each test case for a predefined number of times and collect data associated with each iteration. The collected data can be used for generating the execution report as discussed.

In some instances, the input processing module 201 may receive an error message from one or more test stations indicating an error associated with the execution of a scheduled test case on the test stations. The input processing module 201 may store data associated with the error such as, for example, the error message, the error type, an error log associated with the error, an indication of the test case, information associated with the mobile devices being tested, etc. in data store 211. In various instances, the output module 209 may provide the stored data associated with the error to an entity associated with the application being tested such as, for example, to the tester, to an application developer, to an application server 25 or 31, etc. Upon occurrence of the error, the execution module 207 or any of other components of the mobile automation test platform 200 may take a snapshot of the error. The snapshot may include a snapshot of a status of the mobile device at the time when the error occurred including a snapshot image of a screen of the mobile device, the client device or the test station at the time of error occurrence. The snapshots may also be stored in data store 211 with the error logs.

Subsequent to providing the stored data associated with the error to an entity associated with the application being tested such as the tester or the application developer, the input processing module 201 may receive an input from the entity indicating actions to be taken regarding the error or functions to be executed upon receiving the error message. For example, the entity may request terminating the execution of remaining test cases associated with the same application, or the same mobile device, repeating execution of a failed test case for a predefined number of times, or a combination thereof. In such cases, the registration module 203 verifies the entity's authority and if the entity is authorized to make such request, the registration module 203 sends the request to the execution module 207 to be applied.

In various instances, the test server 109, the mobile automation test platform 200, the test stations and the client devices can be connected by a public network (e.g., network 15), a private network (e.g., network 29, Internet 23), or a combination thereof. The mobile automation test platform 200 may be configured to authenticate users via role based privileges. For example, a user can be authenticated only when using a registered mobile device 13a or 13b or user terminal 27 as a client device and connect to a reserved test station. The mobile automation test platform 200 can verify that test cases are stored only on test stations and run on client devices connected to the test stations via a network 15, 29, or 23.

In various instances, tests can be performed on pre-launched or post-launched mobile devices 13a and 13b. When a pre-launched mobile device is being tested, the mobile device can be located in a laboratory test station where a tester with no physical access to the mobile device can test the mobile device via a remote client device.

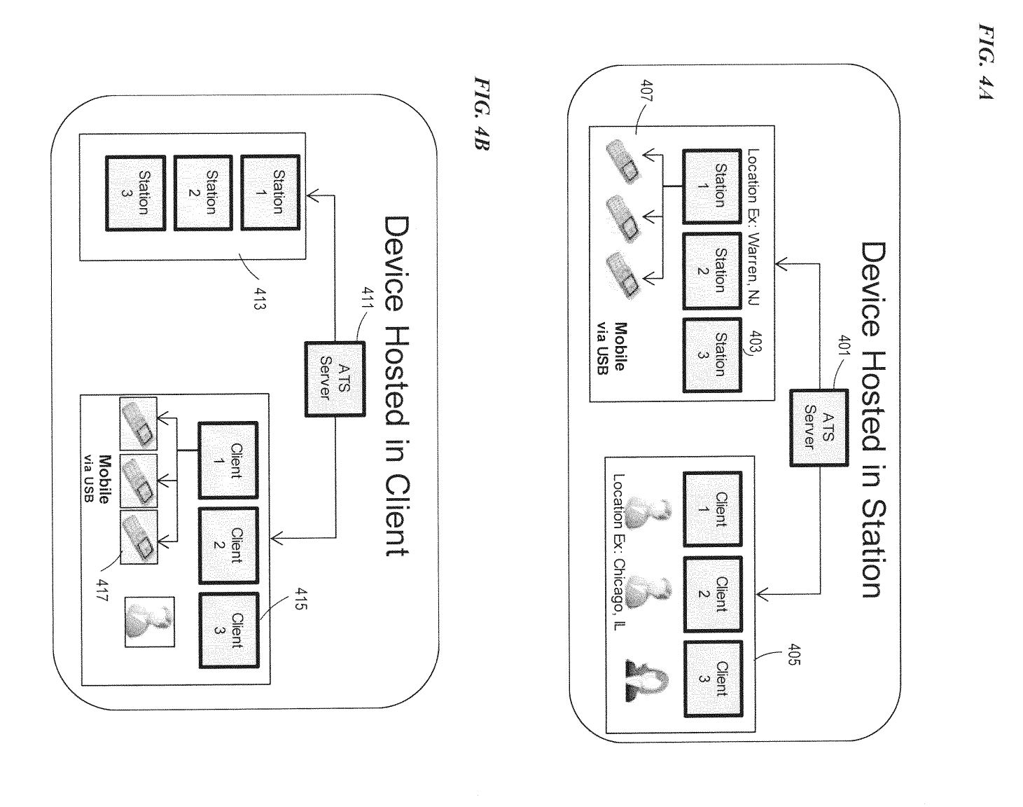

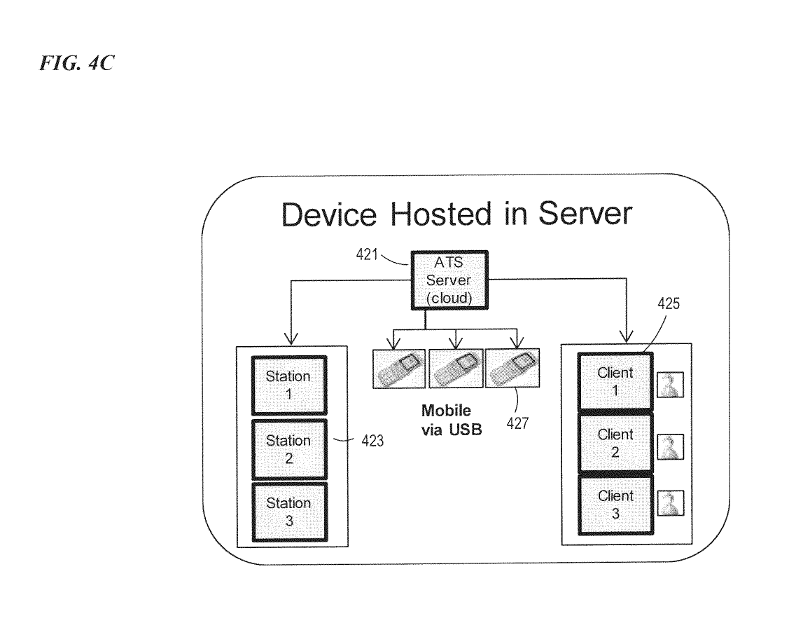

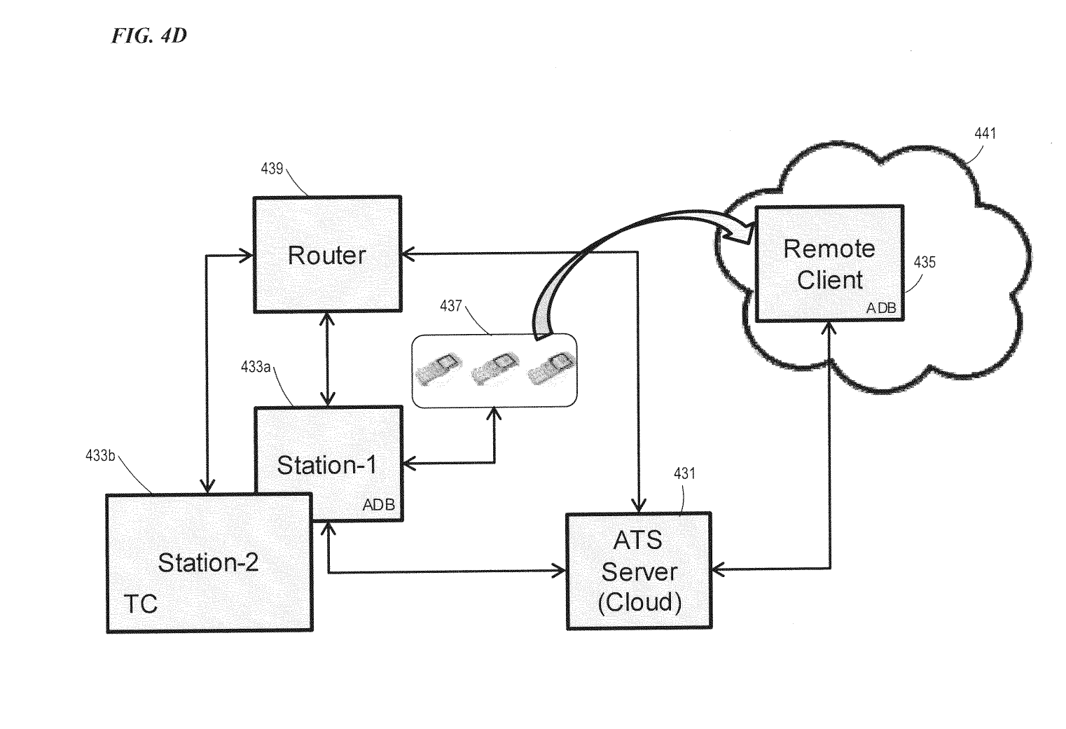

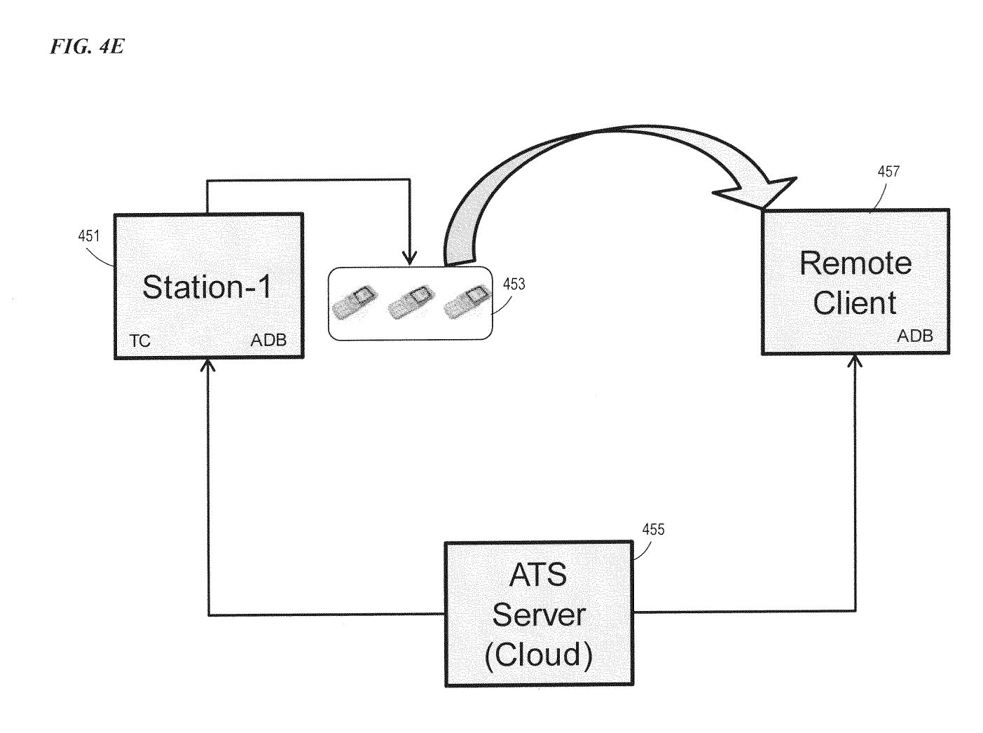

FIGS. 4A-4E illustrate various exemplary configurations for hosting the mobile devices subject to testing process. As shown in FIG. 4A, in some instances, the mobile devices 407 (similar to the mobile devices 13a and 13b of FIG. 1) can be directly hosted on the one or more test stations 403 and accessed by the client devices 405 via the server 401 (similar to the test server 109 or the mobile automation test platform 200 of FIG. 1). In such instances, the user of a client device 405 (e.g., the tester) does not need to have physical access to mobile devices 407, to an operating system, to the applications being tested, etc. Test configurations may be performed by the server 401. The client devices 405 can be located anywhere and access the mobile devices 407 via a network 15, 29, or 23. In such instances, the test stations 403, mobile devices 407 and server 401 may appear to the user of a client device 405 as a black-box that executes the test including the associated functions.

In other instances, as shown in FIG. 4B, the mobile devices 417 (similar to the mobile devices 13a and 13b of FIG. 1) can be hosted on a client device shown as “Client 1” of client devices 415 and connected to the one or more test stations 413 via the 411 (similar to the test server 109 or the mobile automation test platform 200 of FIG. 1). For example, the structure shown in FIG. 4B may be available on-demand to users who have a preference for executing the test on their own end with undisclosed mobile devices 417. In such instances, the user of a client device 415 (e.g., the tester) needs to have physical access to mobile devices 417, to an operating system, to the applications being tested, etc. and to manage physical connectivity of the mobile devices.

In yet other instances, as shown in FIG. 4C, the server 421 (similar to the test server 109 or the mobile automation test platform 200) can connect with the test stations 423, and the client devices 425 via a network 15, 29, 23 of FIG. 1, or a combination thereof. As shown in FIG. 4C, the mobile devices 427 (similar to the mobile devices 13a and 13b of FIG. 1) can be hosted on the server 421 and connected to the one or more test stations 423 and to the client device 425 via the server 421. The structure of FIG. 4C may be used for large scale testing and the server 421 can include a data center or a dedicated storage such as, for example, the data store 211. In addition, the testing can be requested by a team of testers using client devices 425. In some instances, the server 421 can be a cloud-based server, providing the discussed service via a computation cloud.

FIG. 4D shows an example of test automation in a public network. In some instances, the test server 109, the mobile automation test platform 200, the test stations and the client devices can be connected by a public network (e.g., network 15), a private network (e.g., network 29, Internet 23), or a combination thereof. In the configuration depicted in FIG. 4D, the mobile devices 437 (similar to mobile devices 13a and 13b of FIG. 1) are connected to a station 433a. The station 433a in connected to other stations (e.g., 433b) via a router 439 and the router 439 and stations 433a-433b are connected to a test server 431. The test server 431 can be similar to the test server 109, the mobile automation test platform 200 or a combination thereof. A client device 435 is remotely accessing the mobile devices 437 via a public network 441 similar to network 15 of FIG. 1. Using this configuration, a tester can communicate with the mobile automation test platform 200 and the test server 109 via a publicly available network (e.g., the Internet) without a need for access to a specifically provided private network.

FIG. 4E shows an example of test automation in a private network. In some instances, the test server 109, the mobile automation test platform 200, the test stations and the client devices can be connected by a private network (e.g., network 29). In the configuration depicted in FIG. 4D, the mobile device 453 (similar to mobile devices 13a and 13b of FIG. 1) are connected to a station 451 and stations 451 is connected to a test server 455 within a private network. The test server 455 can be similar to the test server 109, the mobile automation test platform 200 or a combination thereof. A client device 457 is remotely accessing the mobile devices 453 within the same private network as the test station 451 and the test server 455.

Those skilled in the art presumably are familiar with the structure, programming and operations of the various types of mobile devices. However, for completeness, it may be useful to consider the functional elements/aspects of two exemplary mobile devices 13a and 13b, at a high-level.

For purposes of such a discussion, FIG. 5 provides a high-level functional block diagram of an exemplary non-touch type mobile device that may utilize the mobile automation test service through a network/system like that shown in FIG. 1. FIG. 5 provides a block diagram illustration of an exemplary non-touch type mobile device 13a. Although the mobile device 13a may be a smart-phone or may be incorporated into another device, such as a personal digital assistant (PDA) or the like, for discussion purposes, the illustration shows the mobile device 13a is in the form of a handset. The handset implementation of the mobile device 13a functions as a normal digital wireless telephone station. For that function, the station 13a includes a microphone 102 for audio signal input and a speaker 104 for audio signal output. The microphone 102 and speaker 104 connect to voice coding and decoding circuitry (vocoder) 106. For a voice telephone call, for example, the vocoder 106 provides two-way conversion between analog audio signals representing speech or other audio and digital samples at a compressed bit rate compatible with the digital protocol of wireless telephone network communications or voice over packet (Internet Protocol) communications.

For digital wireless communications, the handset 13a also includes at least one digital transceiver (XCVR) 108. Today, the handset 13a would be configured for digital wireless communications using one or more of the common network technology types. The concepts discussed here encompass implementations of the mobile device 13a utilizing any digital transceivers that conform to current or future developed digital wireless communication standards. The mobile device 13a may also be capable of analog operation via a legacy network technology.

The transceiver 108 provides two-way wireless communication of information, such as vocoded speech samples and/or digital information, in accordance with the technology of the network 15. The transceiver 108 also sends and receives a variety of signaling messages in support of the various voice and data services provided via the mobile device 13a and the communication network. Each transceiver 108 connects through RF send and receive amplifiers (not separately shown) to an antenna 110. The transceiver may also support various types of mobile messaging services, such as short message service (SMS), enhanced messaging service (EMS) and/or multimedia messaging service (MMS).

The mobile device 13a includes a display 118 for displaying messages, menus or the like; call related information dialed by the user, calling party numbers, etc. A keypad 120 enables dialing digits for voice and/or data calls as well as generating selection inputs, for example, as may be keyed-in by the user based on a displayed menu or as a cursor control and selection of a highlighted item on a displayed screen. The display 118 and keypad 120 are the physical elements providing a textual or graphical user interface. Various combinations of the keypad 120, display 118, microphone 102 and speaker 104 may be used as the physical input output elements of the graphical user interface (GUI), for multimedia (e.g., audio and/or video) communications. Of course other user interface elements may be used, such as a trackball, as in some types of PDAs or smart phones.

In addition to normal telephone and data communication related input/output (including message input and message display functions), the user interface elements also may be used for display of menus and other information to the user and user input of selections, including any needed during mobile automation test process. For example, if used for registration at a mobile automation test platform 200 or requesting the mobile automation test platform for authentication or access authorization to applications.

A microprocessor 112 serves as a programmable controller for the mobile device 13a, in that it controls all operations of the mobile device 13a in accord with programming that it executes, for all normal operations, and for operations involved in the mobile automation test procedure under consideration here. In the example, the mobile device 13a includes flash type program memory 114, for storage of various “software” or “firmware” program routines and mobile configuration settings, such as mobile directory number (MDN) and/or mobile identification number (MIN), etc. The mobile device 13a may also include a non-volatile random access memory (RAM) 116 for a working data processing memory. Of course, other storage devices or configurations may be added to or substituted for those in the example. In a present implementation, the flash type program memory 114 stores firmware such as a boot routine, device driver software, an operating system, call processing software and vocoder control software, and any of a wide variety of other applications, such as client browser software and short message service software. The memories 114, 116 also store various data, such as telephone numbers and server addresses, downloaded data such as multimedia content, and various data input by the user. Programming stored in the flash type program memory 114, sometimes referred to as “firmware,” is loaded into and executed by the microprocessor 112.

As outlined above, the mobile device 13a includes a processor, and programming stored in the flash memory 114 configures the processor so that the mobile device is capable of performing various desired functions, including in this case the functions involved in the technique for providing mobile automation test services.

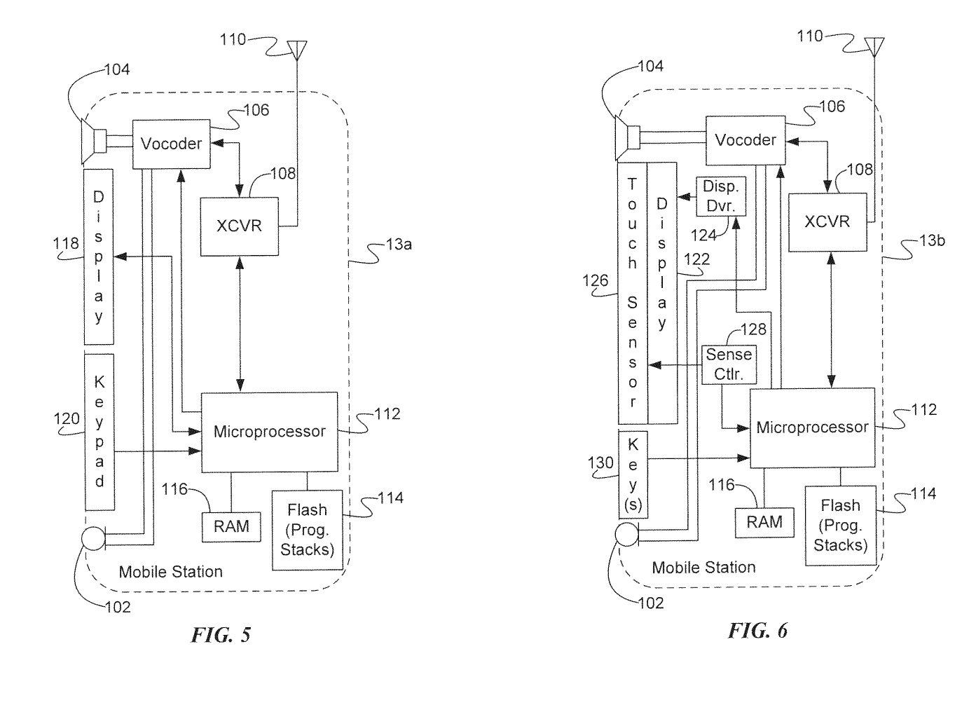

For purposes of such a discussion, FIG. 6 provides a high-level functional block diagram of an exemplary touch screen type mobile device that may utilize the mobile automation test service through a network/system like that shown in FIG. 1. FIG. 6 provides a block diagram illustration of an exemplary touch screen type mobile device 13b. Although possible configured somewhat differently, at least logically, a number of the elements of the exemplary touch screen type mobile device 13b are similar to the elements of mobile device 13a, and are identified by like reference numbers in FIG. 6. For example, the touch screen type mobile device 13b includes a microphone 102, speaker 104 and vocoder 106, for audio input and output functions, much like in the earlier example. The mobile device 13b also includes at least one digital transceiver (XCVR) 108, for digital wireless communications, although the handset 13b may include an additional digital or analog transceiver. The concepts discussed here encompass implementations of the mobile device 13b utilizing any digital transceivers that conform to current or future developed digital wireless communication standards. As in the station 13a, the transceiver 108 provides two-way wireless communication of information, such as vocoded speech samples and/or digital information, in accordance with the technology of the network 15. The transceiver 108 also sends and receives a variety of signaling messages in support of the various voice and data services provided via the mobile device 13b and the communication network. Each transceiver 108 connects through RF send and receive amplifiers (not separately shown) to an antenna 110. The transceiver may also support various types of mobile messaging services, such as short message service (SMS), enhanced messaging service (EMS) and/or multimedia messaging service (MMS).

As in the example of station 13a, a microprocessor 112 serves as a programmable controller for the mobile device 13b, in that it controls all operations of the mobile device 13b in accord with programming that it executes, for all normal operations, and for operations involved in the mobile automation test procedure under consideration here. In the example, the mobile device 13b includes flash type program memory 114, for storage of various program routines and mobile configuration settings. The mobile device 13b may also include a non-volatile random access memory (RAM) 116 for a working data processing memory. Of course, other storage devices or configurations may be added to or substituted for those in the example. Hence, outlined above, the mobile device 13b includes a processor, and programming stored in the flash memory 114 configures the processor so that the mobile device is capable of performing various desired functions, including in this case the functions involved in the technique for providing mobile automation test service.

In the example of FIG. 5, the user interface elements included a display and a keypad. The mobile device 13b may have a limited number of key 130, but the user interface functions of the display and keypad are replaced by a touchscreen display arrangement. At a high level, a touchscreen display is a device that displays information to a user and can detect occurrence and location of a touch on the area of the display. The touch may be an actual touch of the display device with a finger, stylus or other object, although at least some touchscreens can also sense when the object is in close proximity to the screen. Use of a touchscreen display as part of the user interface enables a user to interact directly with the information presented on the display.

Hence, the exemplary mobile device 13b includes a display 122, which the microprocessor 112 controls via a display driver 124, to present visible outputs to the device user. The mobile device 13b also includes a touch/position sensor 126. The sensor 126 is relatively transparent, so that the user may view the information presented on the display 122. A sense circuit 128 sensing signals from elements of the touch/position sensor 126 and detects occurrence and position of each touch of the screen formed by the display 122 and sensor 126. The sense circuit 128 provides touch position information to the microprocessor 112, which can correlate that information to the information currently displayed via the display 122, to determine the nature of user input via the screen.

The display 122 and touch sensor 126 (and possibly one or more keys 130, if included) are the physical elements providing the textual and graphical user interface for the mobile device 13b. The microphone 102 and speaker 104 may be used as additional user interface elements, for audio input and output, including with respect to some mobile automation test related functions.

The structure and operation of the mobile devices 13a and 13b, as outlined above, were described by way of example, only. As shown by the above discussion, functions relating to the mobile automation test service, via a graphical user interface of a mobile device may be implemented on computers connected for data communication via the components of a packet data network, operating as shown in FIG. 1. Although special purpose devices may be used, such devices also may be implemented using one or more hardware platforms intended to represent a general class of data processing device commonly used to run “server” programming so as to implement the mobile automation test functions discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for mobile automation test service. The software code is executable by the general-purpose computer that functions as the mobile automation test platform and/or that functions as a user terminal device. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for mobile automation test service, in essentially the manner performed in the implementations discussed and illustrated herein.

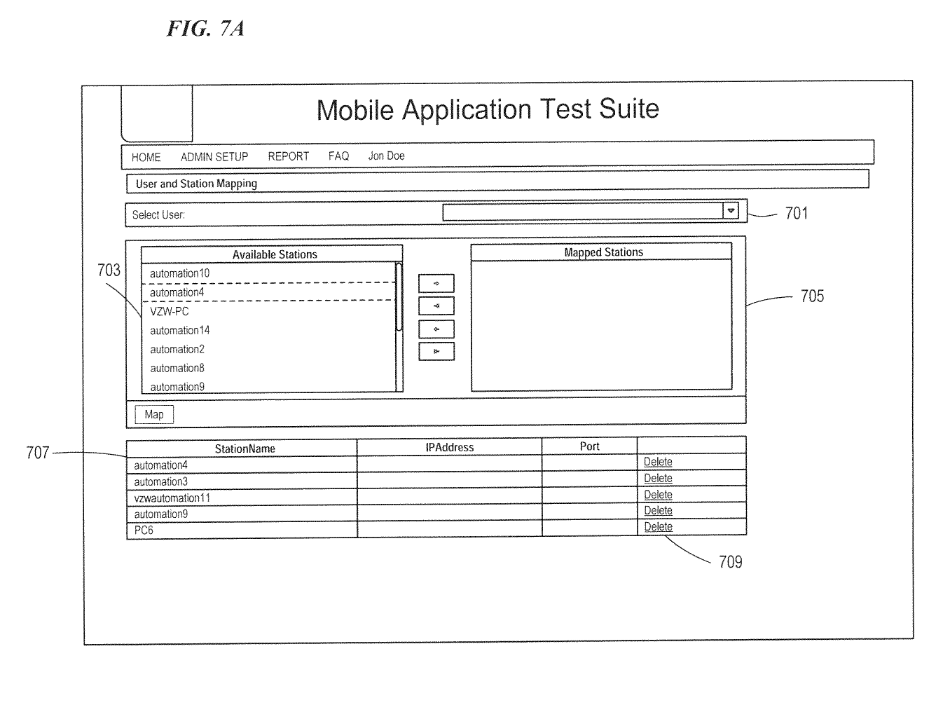

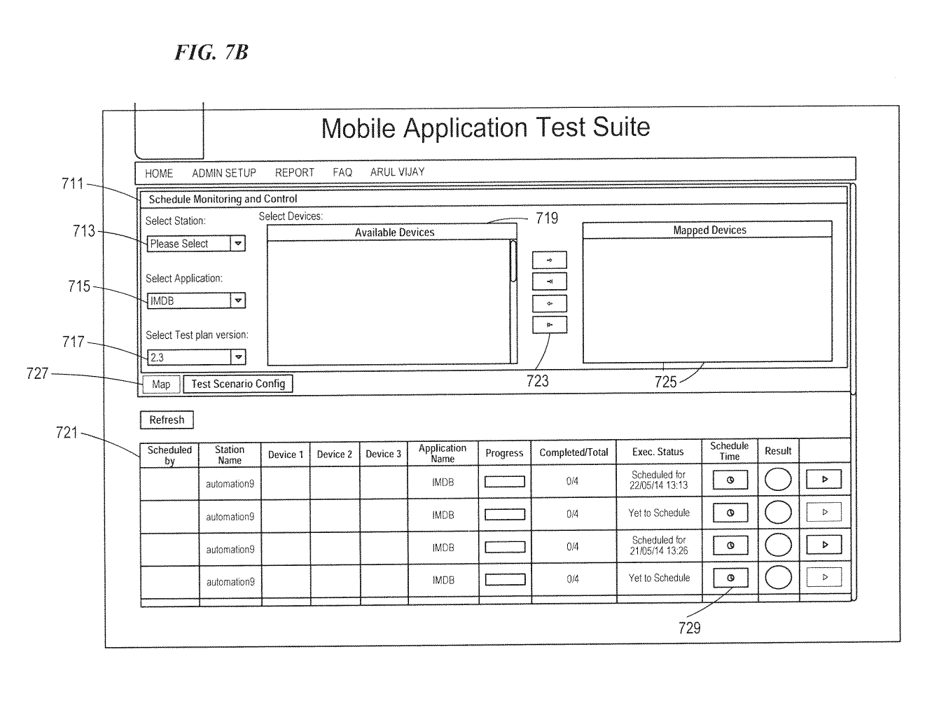

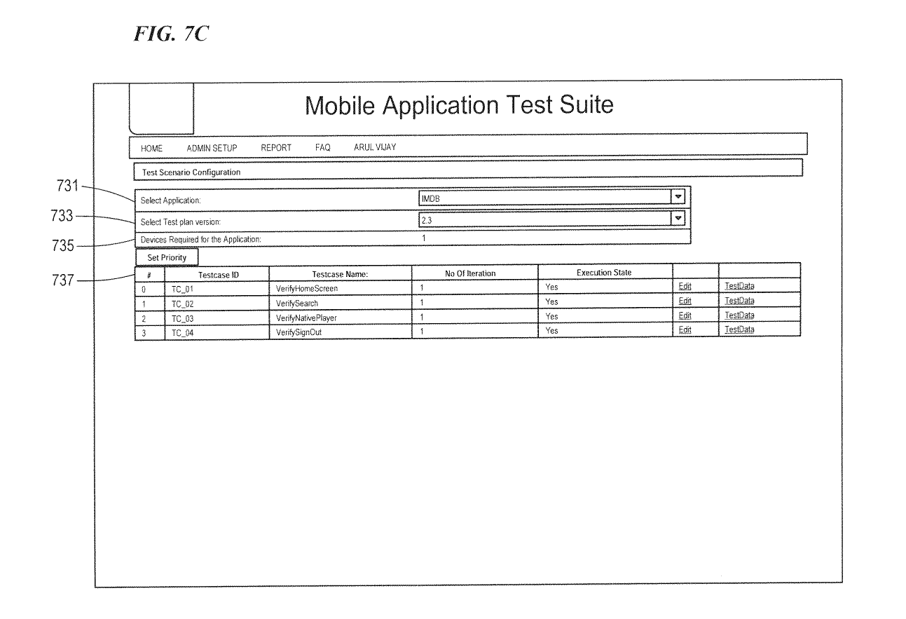

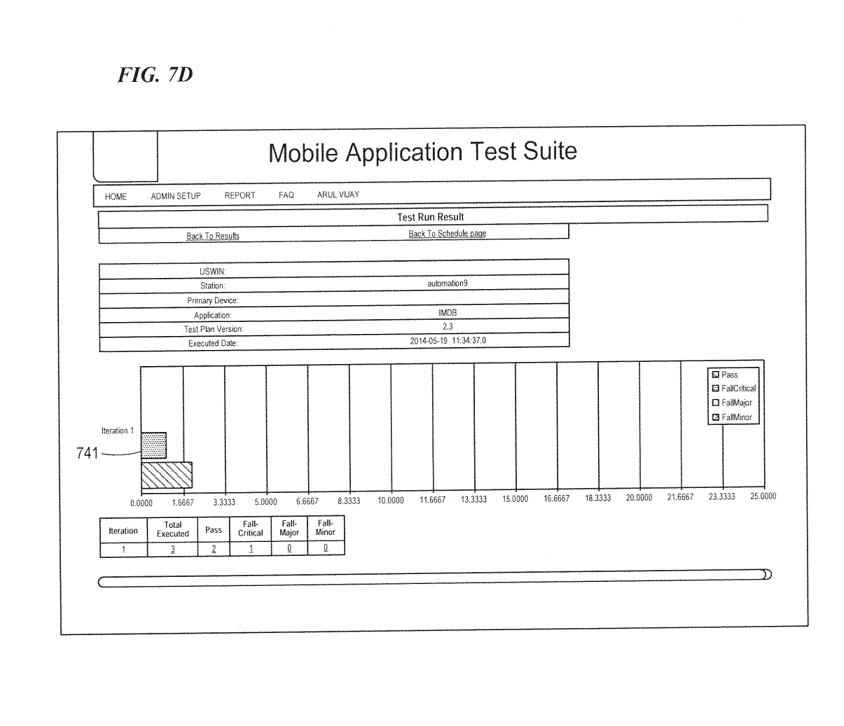

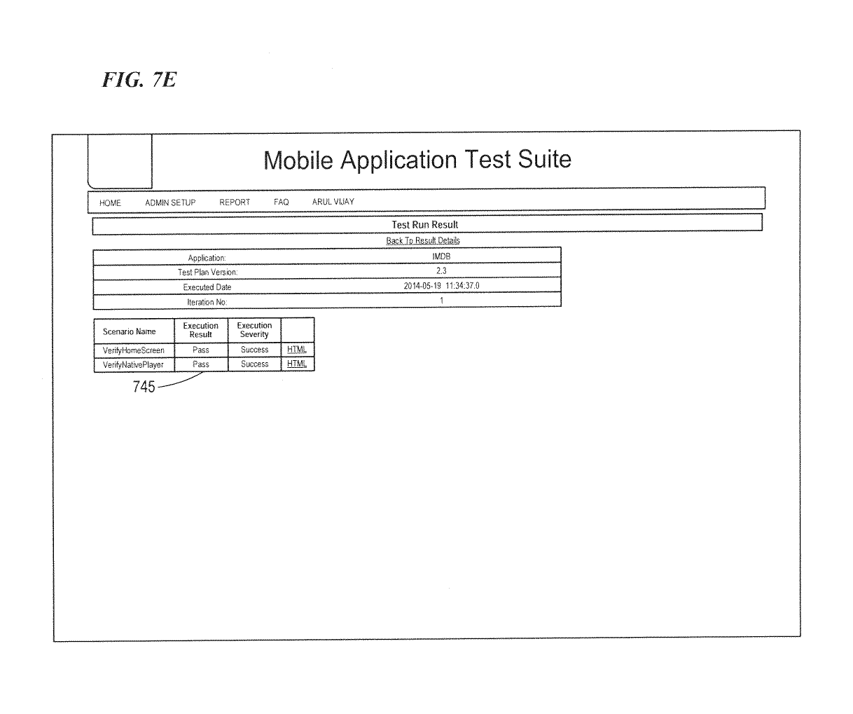

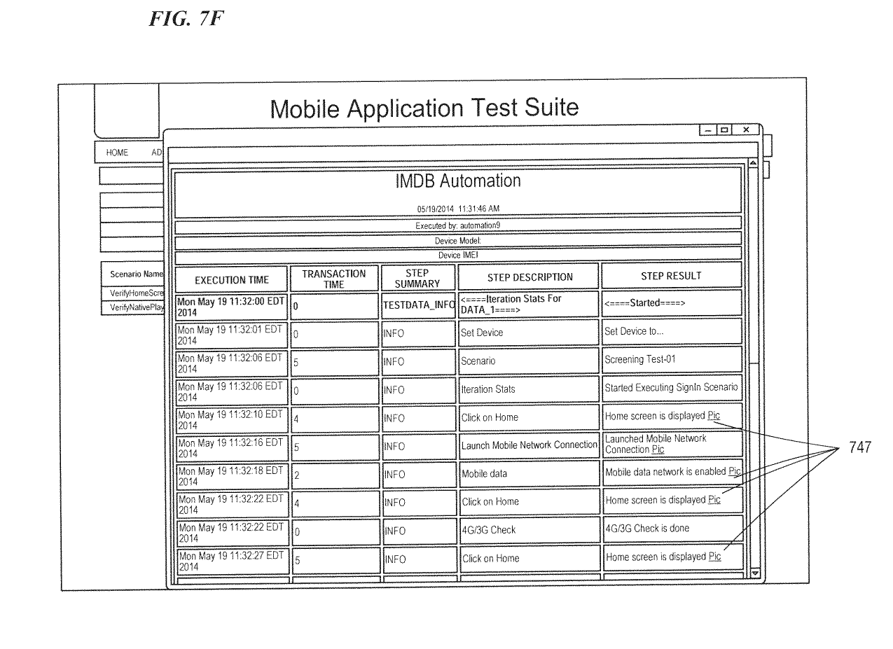

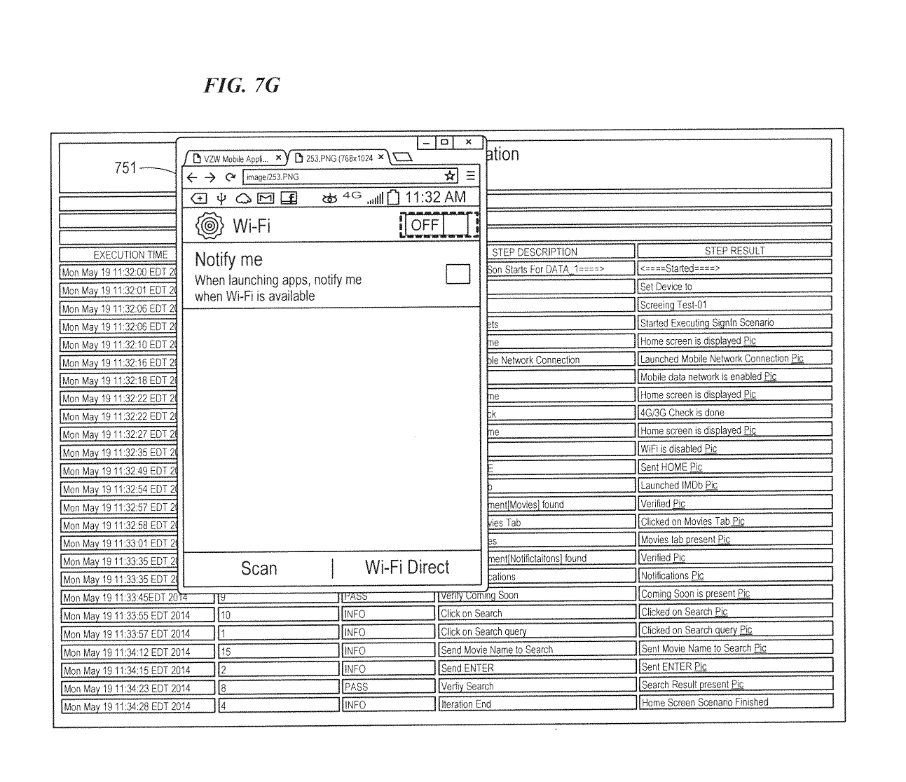

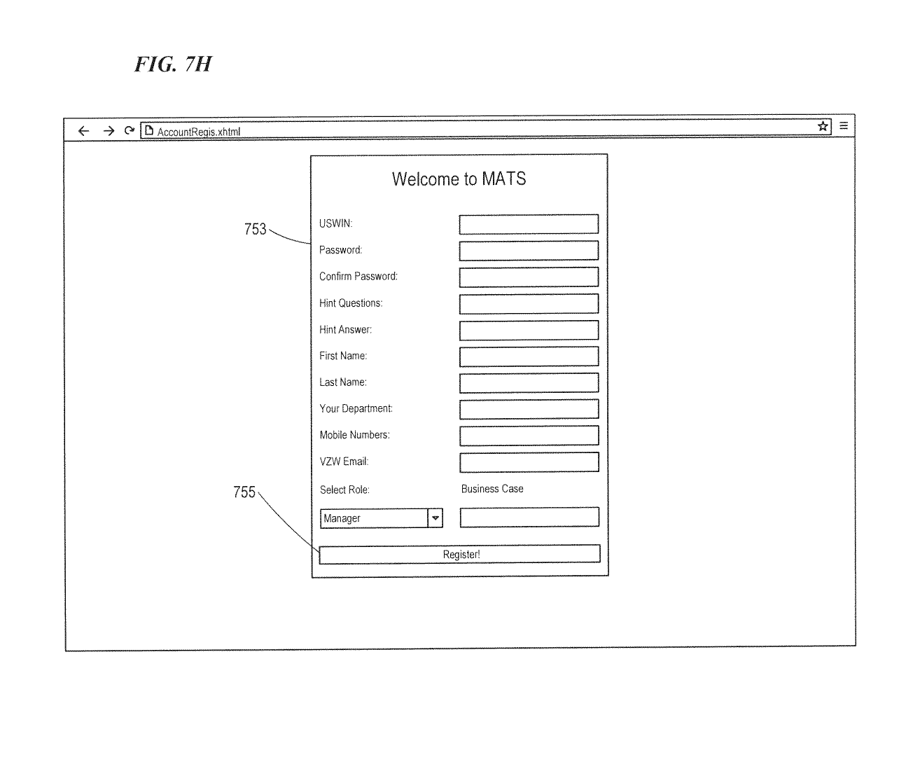

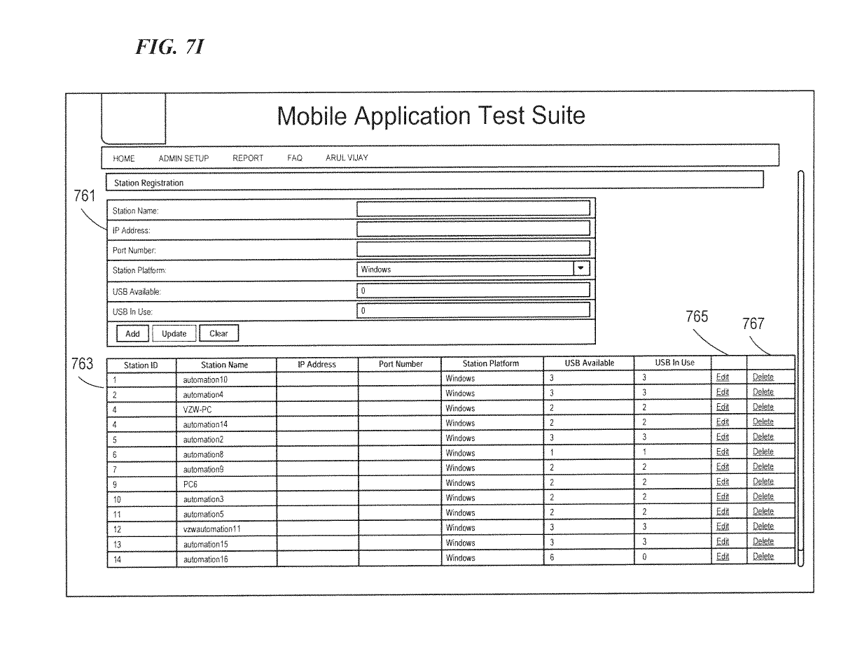

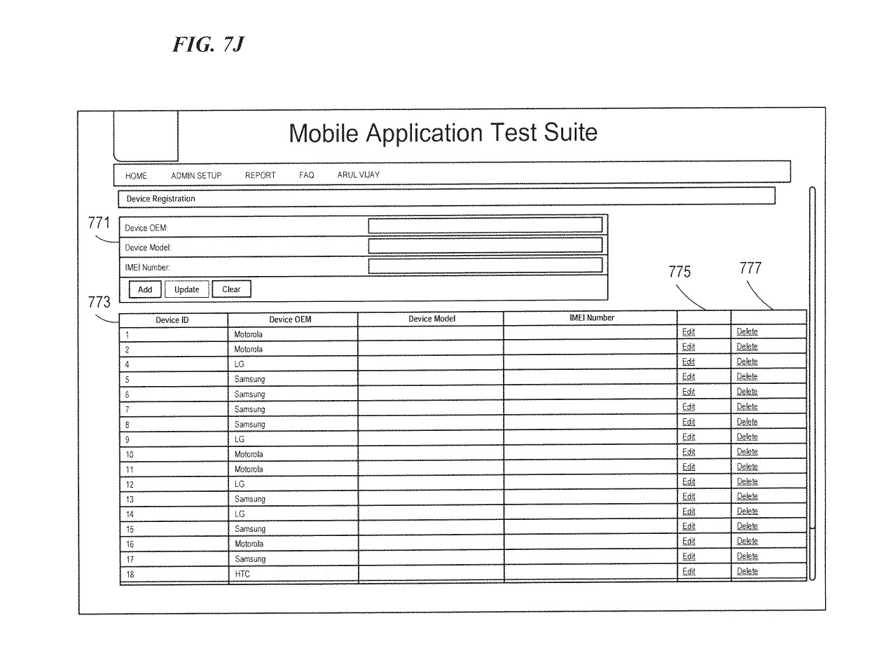

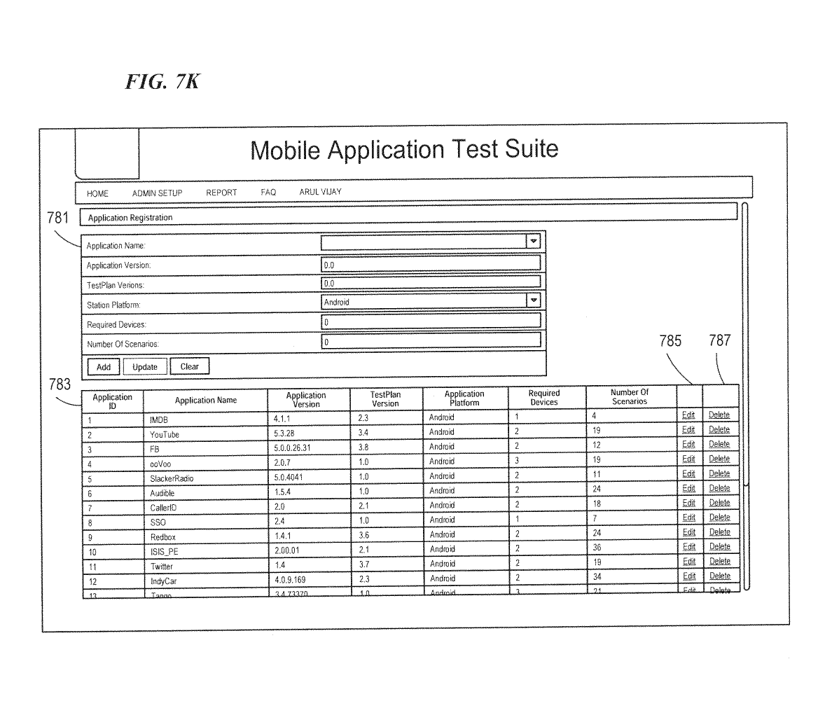

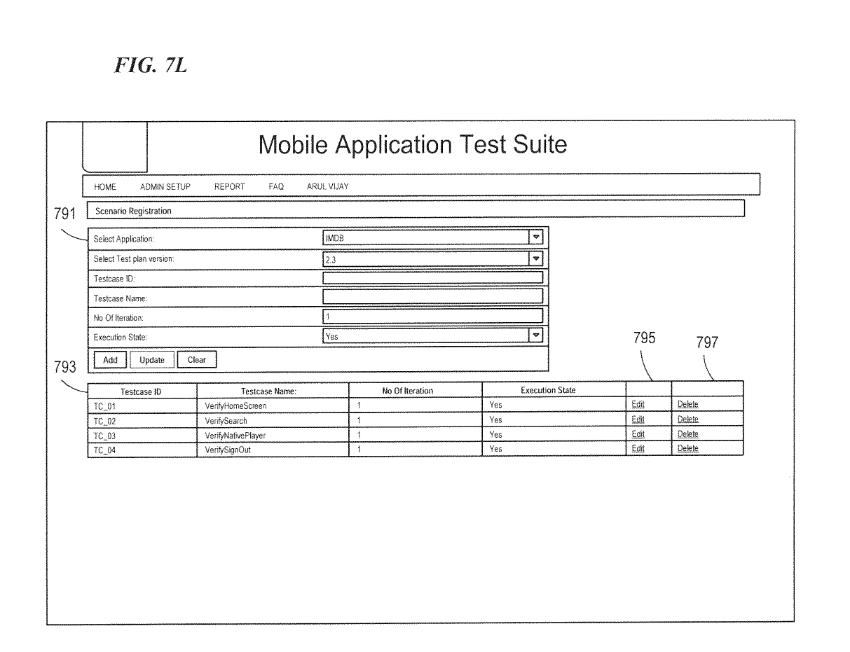

FIGS. 7A-7L are exemplary screenshots provided by the mobile automation test platform shown in FIG. 2. FIG. 7A shows a screen for reservation of a test station for a user. In some instances, a registered user can be selected from a list of registered users via a drop down menu 701. Upon selection of a user, an available test station from the list 703 can be assigned to the user by selecting the station from the list 703 and adding the station name to list 705 of mapped stations. In addition, the user can see a list 707 of selected test stations. The user may need to release a selected test station by pressing a “delete” button 709.

FIG. 7B shows a screen where a test scheduling by the scheduling module 205 of FIG. 2 is initiated. Upon completion of registration process by the registration module 203 and reservation of test stations as shown in FIG. 7A, a user can log in (the login screen not shown). Upon a successful login by the user, the user can be provided the screen of FIG. 7B. The screen of FIG. 7B includes a table 711 for schedule monitoring and control provided by the scheduling module 205. The user can select a test station from drop down menu 713. The user can then select an application to be tested from a drop down menu 715 and a test plan (e.g., a test case or a version of a test case) from drop down menu 717. The user can also select a set of mobile devices 13a or 13b that the user is going to test, from a table 719 of available mobile devices. The user's selections are displayed in table 721. The table 721 also shows the test progress, status, various statistics, and results for all the scheduled tests for the user. The user can select mobile devices of list 719 by using buttons 723 and move the mobile devices to table 725 of mapped devices or remove the mobile devices from list 725. This allows the user to test only selected mobile devices of list 725 and not all the available mobile devices of list 719. The user can then select the map button 727 to map the set of mobile devices to the selected test station and the selected application. The mobile automation test platform 200 can automatically configure the test cases based on the mapping by the user and execute the test cases based on the configuration. The automatic configuration of a test case by the mobile automation test platform 200 may include selecting one or more components (e.g., tests) to be included in the test case based on, for example, model and/or configuration of the mobile device being tested, version and/or requirements of the application being tested, etc. The automatic configuration may also include automatically scheduling execution of the test cases for each mobile device.

In some instances, the mobile automation test platform 200 schedules execution of the test cases for each mobile device from the set of mobile devices and populate the table 721 based on the schedule showing indications of test process based on the user selections and test results for each test case. The mobile automation test platform 200 may enable the user to modify table 721, for example, by revising a number of times for each test case to be performed. The user can also select schedule times 729 for the tests to start automatically at the selected time.

FIG. 7C shows a user interface configured to allow the user to set up various test scenarios. This user interface allows a user to modify configuration of the test cases and choose which test cases to be executed by assigning a priority to the selected test cases. The user can select an application using an application list 731, a test plan version using a test plan list 733, and the number of devices required by an application using the application block 735. In some instances, the number of mobile devices required for an application is automatically populated by the scheduling module 205, for example, based on the application requirements provided by the application server 31 or 25. Table 737 shows the test cases, the order in which test cases will be executed, and number of execution iterations. Table 737 also allows the user to modify the table by editing test cases.

FIG. 7D shows an exemplary test report upon completion of test execution. The report is produced by the execution module 207. The report shows a summary of the test cases performed, and number of passes versus number of fails and graphs 741 associated with the results.

FIG. 7E is a screen that allows the user to access details of test results. For example, by clicking on “pass” in table 745 the user can access a list of test cases with a pass result and access each individual test case.

FIG. 7F is an exemplary table result for a test case showing details associated with the test case. The table results show events at various steps of the test process. The results include screenshots captured during the test process, as previously discussed with regards to FIG. 3. The screenshot for each step can be accessed by selecting links 747 labeled as “Pic”. For example, the user may setup the test to be executed overnight. However, since the user is not present during the test, the user cannot see failure screens associated with the test. The screenshots of the failure allow the user to observe events happening at the time of test failure. In addition, there are options for the user to capture every screenshot, execution step, or configuration step throughout the test execution process. The user can also send the screenshots to the mobile device manufacturer or the application developer to address the failures as part of result-sharing.

In some instances, the mobile automation test platform 200 allows the user to have access to various setups of the testing process. For example, FIG. 7G shows a window 751 enabling the user to check WiFi availability. The user can monitor WiFi availability and get notification when WiFi is available.

FIG. 7H shows a screen for user account registration at the registration module 203. The user can enter identification data, password and other account information in table 753 and press button 755 to register at the mobile test automation platform 200. The registration data can be stored by the registration module 203 in data store 211.

FIG. 7I shows a screen for test station registration at the registration module 203. A user (e.g., a tester, a system administrator, etc.) can enter registration data of a test station such as, for example, Station name, Internet Protocol (IP) Address, Port Number, etc. (as shown in FIG. 7I) in table 761. The user can check a list 763 of the registered test stations and modify the registrations by pressing buttons 765 or 767. The registration data can be stored by the registration module 203 in data store 211.

FIG. 7J shows a screen for mobile device registration at the registration module 203. A user can enter registration data of a mobile device 13a or 13b such as, for example, Original Equipment Manufacturer (OEM), device model, etc. (as shown in FIG. 7J) in table 771. The user can check a list 773 of the registered mobile devices and modify the registrations by pressing buttons 775 or 777. The registration data can be stored by the registration module 203 in data store 211.

FIG. 7K shows a screen for application registration at the registration module 203. A user can enter registration data of an application provided by the application server 25 or 31 such as, for example, application name, application version, a test-plan version (e.g., a set of test case for the application), etc. (as shown in FIG. 7K) in table 781. The user can check a list 783 of the registered applications and modify the registrations by pressing buttons 785 or 787. The registration data can be stored by the registration module 203 in data store 211.

FIG. 7L shows a screen for and test case registration at the registration module 203. A user can enter registration data of a test case provided by the application server 25 or 31 or by a test server 109 such as, for example, an application that the test is executed on, a test-plan version (e.g., a set of test cases for the application), a test case ID, a test case name, etc. (as shown in FIG. 7L) in table 791. The user can check a list 793 of the registered test cases and modify the registrations by pressing buttons 795 or 797. The registration data can be stored by the registration module 203 in data store 211.

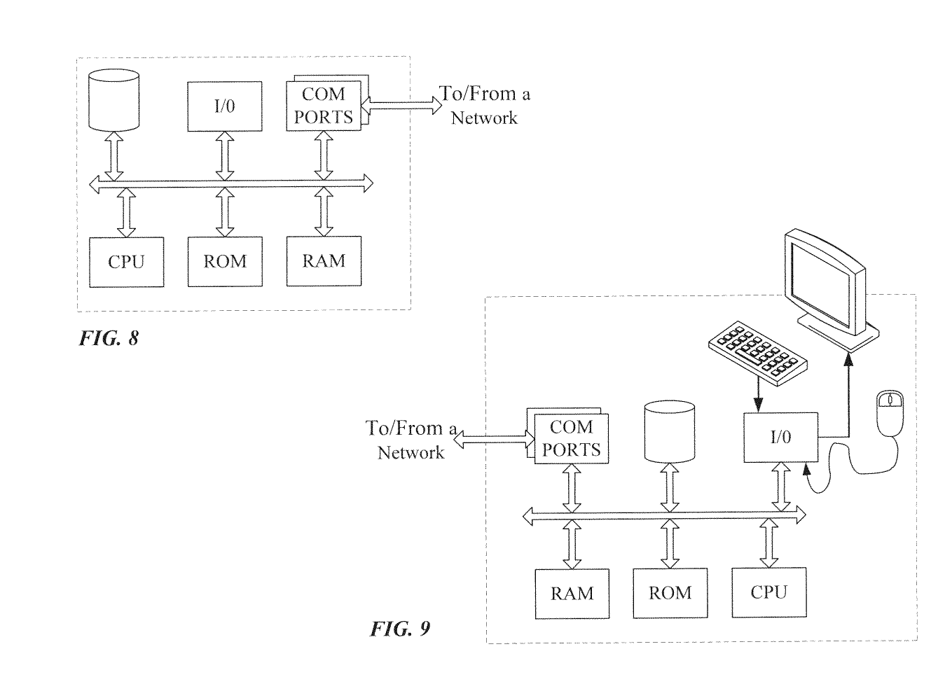

FIGS. 8 and 9 provide functional block diagram illustrations of general purpose computer hardware platforms. FIG. 8 illustrates a network or host computer platform, as may typically be used to implement a server. FIG. 9 depicts a computer with user interface elements, as may be used to implement a personal computer or other type of work station or terminal device, although the computer of FIG. 9 may also act as a server if appropriately programmed. It is believed that those skilled in the art are familiar with the structure, programming and general operation of such computer equipment and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

A computer type user terminal device, such as a PC or tablet computer, similarly includes a data communication interface CPU, main memory and one or more mass storage devices for storing user data and the various executable programs (see FIG. 8). A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature, and it is presumed that those skilled in the art are adequately familiar therewith.

Hence, aspects of the methods of providing mobile automation test services outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile automation test platform 200 into the computer platform of the application server 25 that will be the application server for the mobile devices 13a, and 13b or the user terminal 27. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the mobile automation test service, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

While the above discussion primarily refers to processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

Many of the above described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions.

In this specification, the term “software” is meant to include firmware residing in read-only memory or applications stored in magnetic storage, which can be read into memory for processing by a processor. Also, in some implementations, multiple software operations can be implemented as sub-parts of a larger program while remaining distinct software operations. In some implementations, multiple software operations can also be implemented as separate programs. Finally, any combination of separate programs that together implement a software invention described herein is within the scope of the invention. In some implementations, the software programs, when installed to operate on one or more electronic systems, define one or more specific machine implementations that execute and perform the operations of the software programs.

A computer program (also known as a program, software, software application, script, application, or code) can be written in any form of programming language, including compiled or interpreted language, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

It is understood that any specific order or hierarchy of steps in the processes disclosed herein is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

The implementations described hereinabove are further intended to explain and enable others skilled in the art to utilize the invention in such, or other, implementations and with the various modifications required by the particular applications or uses of the invention. Accordingly, the description is not intended to limit the invention to the form disclosed herein.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus the following claims are hereby incorporated into the Detailed Description, with each claim standing on its own as a separately claimed subject matter.

What is claimed is:

1. A method comprising:
registering, at a server, a plurality of mobile devices, a plurality of applications associated with the plurality of mobile devices, and a plurality of test cases, each test case associated with at least one of the plurality of mobile devices and at least one of the plurality of applications;
registering, at the server, a plurality of test stations for executing the plurality of test cases;
scheduling, at the server, a plurality of test cases on the plurality of mobile devices connected to the plurality of test stations based on a request received from at least one of a plurality of client devices associated with a user;
analyzing, at the server, timing of the scheduled plurality of test cases and upon determining an occurrence of the scheduled timing, automatically executing, at the server, the scheduled plurality of test cases on the plurality of test stations; and
sending the execution results to at least one of the plurality of client devices for display.

2. The method of claim 1, further comprising registering a plurality of users at the server, wherein the request is from one of the plurality of registered users.

3. The method of claim 1, wherein each of the plurality of mobile devices is directly hosted on at least one of the plurality of test stations and accessed by at least one of the plurality of client devices via the server.

4. The method of claim 1, wherein each of the plurality of mobile devices is hosted on at least one of the plurality of client devices and connected to at least one of the plurality of test stations via the server.

5. The method of claim 1, wherein each of the plurality of mobile devices is hosted on the server and connected to at least one of the plurality of test stations and to at least one of the plurality of client devices via the server.

6. The method of claim 1, wherein the user is permitted to start, stop, or pause the execution of the scheduled test cases via at least one of the plurality of client devices.

7. The method of claim 1, wherein the server, the plurality of test stations and the plurality of client devices are connected by a public network, a private network, or a combination thereof.

8. The method of claim 1, wherein the server comprises a computation cloud.

9. The method of claim 1, wherein the automatically executing the plurality of test cases further comprises executing multiple iterations of each test case from the plurality of test cases for a predefined number of times.

10. The method of claim 1, wherein the automatically executing the plurality of test cases further comprises:
storing an execution log associated with the execution, wherein the storing comprises taking one or more screenshots of one or more screens associated with the execution; and
generating an execution report based on the execution log.

11. The method of claim 10, wherein:
the executing report comprises statistics associated with the execution including a success rate, a failure rate, or a combination thereof, and
utilizing the execution report to certify the plurality of executed test cases, evaluate whether to re-run failed test cases or file the failed test cases in a bug tracking system.

12. The method of claim 1, wherein the automatically executing comprises:
receiving an error message indicating an error associated with the execution of one of the scheduled test cases on at least one of the plurality of test stations;
storing an error log associated with the error, wherein the storing comprises taking a screenshot of the error occurrence; and
providing the stored error log to an entity associated with at least one of the plurality of applications.

13. The method of claim 12, wherein the entity is the user and/or an application developer.

14. The method of claim 12, further comprising:
receiving an input from the entity identifying one or more functions to be executed upon receiving the error message, wherein the one or more function comprise terminating the execution of remaining test cases, repeating execution of a failed test case for a predefined number of times, or a combination thereof.

15. A system comprising:
a processing device; and
a memory storing executable instructions that, when executed by the processing device, cause the processing device to:
register, at a server, a plurality of mobile devices, a plurality of applications associated with the plurality of mobile devices, and a plurality of test cases each test case associated with at least one of the plurality of mobile devices and at least one of the plurality of applications;
register, at the server, a plurality of test stations for executing the plurality of test cases;
schedule, at the server, a plurality of test cases on a plurality of mobile devices connected to the plurality of test stations based on a request received from at least one of a plurality of client devices associated with a user;
analyze, at the server, timing of the scheduled plurality of test cases and upon determining an occurrence of the scheduled timing;
automatically execute, at the server, the scheduled plurality of test cases on the plurality of test stations; and
send the execution results to at least one of the plurality of client devices for display.

16. The system of claim 15, wherein the processing device caused to automatically executing the plurality of test cases is further caused to execute multiple iterations of each test case from the plurality of test cases for a predefined number of times.

17. A method comprising:
displaying a user interface to a user on a client device, the user interface configured to include a plurality of input fields for receiving a plurality of inputs from the user, the plurality of input fields including a first input field for identifying a plurality of test stations, a second input field for identifying a plurality of mobile devices, a third input field for identifying a plurality of applications;
receiving, via the user interface and from the user, input identifying at least one test station from the plurality of test stations, a plurality of applications, a plurality of mobile devices;
enabling via the user interface the user to map the plurality of mobile devices to the test station and the plurality of applications;
automatically configuring a plurality of test cases based on the mapping by the user for execution on the plurality of mobile devices; and
executing the plurality of configured test cases on the mobile devices and displaying a result of the test cases to the user.

18. The method of claim 17, wherein the automatically configuring the plurality of test cases comprises:
selecting one or more tests to be included in each test case of the plurality of test cases, automatically scheduling execution of the plurality of test cases for each mobile device from the plurality of mobile devices, or a combination thereof.

19. The method of claim 18, the execution further comprising:
enabling execution of the plurality of test cases for each mobile device from the plurality of mobile devices based on the scheduling; and
displaying a second user interface to the user on the client device, the second user interface configured to include an indication of the schedule, a process indicator, and a result indicator for each test case from the plurality of test cases.

20. The method of claim 17, further comprising enabling the user to set a priority for each of the plurality of test cases such that the execution of the plurality of test cases is based on the priority.
